(19) United States
(12) Patent Application Publication
(10) Pub. No.: US 2021/0245328 A1
(43) Pub. Date: Aug. 12, 2021

(54) Abrasive solvent jet cutting system and method

(71) Applicant: ENFIELD ENGINE COMPANY, INC., Enfield, NH (US)

(72) Inventors: Nicholas A Sanders, Enfield, NH (US); Ryan T.K. Sanders, White River Jct, VT (US)

(21) Appl. No.: 17/172,824

(22) Filed: Feb. 10, 2021

Related U.S. Application Data
(60) Provisional application No. 62/972,611, filed on Feb. 10, 2020.

(51) Int. Cl. B24C 1/04; B26F 3/00; B24C 7/00; B24C 11/00

(52) U.S. Cl. CPC B24C 1/045; B24C 11/00; B24C 7/0007; B26F 3/004

(57) ABSTRACT

A system and method for abrasive solvent jet cutting including generating, with a high-pressure pump, a jet of rapidly moving liquid comprising a retrograde soluble solute dissolved in solvent; directing the jet of rapidly moving liquid through an orifice to cut a target, such that the retrograde soluble solute is configured to precipitate out of the rapidly moving liquid after transitioning through the orifice. An apparatus for abrasive solvent jet cutting including a storage vessel configured to store a retrograde soluble solute; a high-pressure solvent compartment; and a mixing tube configured to eject a jet of rapidly moving liquid through an orifice, the liquid comprising solvent from the compartment and the retrograde soluble solute from the vessel, such that the retrograde soluble solute is configured to precipitate out of the rapidly moving liquid after ejecting from the orifice.

### CROSS-REFERENCE TO RELATED APPLICATIONS

The present application claims the benefit of U.S. provisional application No. 62/972,611, filed on Feb. 10, 2020, the entire disclosure of which is incorporated by reference as if set forth in its entirety herein. This application is related to international (PCT) Application No. ______ (Attorney Docket ENE-001PC) for ABRASIVE SOLVENT JET CUTTING SYSTEM AND METHOD and filed concurrently herewith, which is incorporated herein by reference for all purposes.

### TECHNICAL FIELD

Embodiments described herein generally relate to abrasive jet cutting systems and methods and, more particularly, to systems and methods with retrograde soluble solute configured to precipitate out of a rapidly moving jet of liquid after transitioning through an orifice.

### BACKGROUND

Current abrasive water jet systems add garnet or a similar abrasive to a water jet downstream of the high-pressure jetting orifice. These abrasives are then accelerated to a useable speed in a downstream mixing tube. Getting the abrasive up to a useable speed can cause wear and clogging issues in the mixing tube. Furthermore, even after successfully accelerating the abrasive and water jet through the mixing tube can result in a low jet energy incapable of cutting certain materials. The typical speed of cutting for materials of large thicknesses, especially on steel, can be very slow with commercially available abrasive water jet streams.

To remedy this, currently available systems use different-sized abrasives to achieve faster acceleration and a more effective cutting method. Some systems also try to add abrasive upstream to a high-pressure jetting orifice in a slurry jet system. However, abrasive particle size and particle suspension can cause orifice damage and clogging, even in slurry jet systems.

A need exists, therefore, for methods and devices that overcome the disadvantages of existing cutting methods.

### SUMMARY

This summary is provided to introduce a selection of concepts in a simplified form that are further described below in the Detailed Description. This summary is not meant or intended to identify or exclude key features or essential features of the claimed subject matter, nor is it intended to be used as an aid in determining the scope of the claimed subject matter.

According to one aspect, embodiments relate to a method for abrasive solvent jet cutting. In some embodiments, the method includes generating, with a high-pressure pump, a jet of rapidly moving liquid comprising a retrograde soluble solute dissolved in solvent; and directing the jet of rapidly moving liquid through an orifice to cut a target, such that the retrograde soluble solute is configured to precipitate out of the rapidly moving liquid after transitioning through the orifice.

In some embodiments, the retrograde soluble solute comprises at least one of gypsum, anhydrite, bassanite, glauberite, cesanite, eugsterite, hydroglauberite, syngenite, gorgeyite, polyhalite, koktaite, ye'elimite, ettringite, bentorite, celestine, kalistrontite, or baryte.

In some embodiments, the solvent is an aqueous solution.

In some embodiments, the retrograde soluble solute is configured to precipitate out of solution when the temperature of the jet is above 25° C.

In some embodiments, the high-pressure pump is at least one of a solvent jet intensifier pump, a solvent jet crankshaft pump, or a direct-drive pump.

In some embodiments, the method further includes maintaining the solvent and the retrograde soluble solute at a temperature of between 15° C. and 35° C. before directing the jet through the orifice.

In some embodiments, the retrograde soluble solute is a sulfate.

In some embodiments, the method further includes adding the retrograde soluble solute to the solvent in a reservoir connecting to the high-pressure pump.

In some embodiments, the solvent is water.

In some embodiments, directing the jet of rapidly moving liquid through the orifice causes the temperature of the jet to rise and the retrograde soluble solute to precipitate out of the rapidly moving liquid.

In another aspect, embodiments relate to an apparatus for abrasive solvent jet cutting. In some embodiments, the apparatus includes a storage vessel configured to store a retrograde soluble solute; a high-pressure solvent compartment; and a mixing tube configured to eject a jet of rapidly moving liquid through an orifice, the liquid comprising solvent from the compartment and the retrograde soluble solute from the vessel, such that the retrograde soluble solute is configured to precipitate out of the rapidly moving liquid after ejecting from the orifice.

In some embodiments, the apparatus further includes a cutting fluid chiller configured to maintain the solvent in the high-pressure solvent compartment at a temperature between 15° C. and 35° C.

In some embodiments, the retrograde soluble solute comprises at least one of gypsum, anhydrite, bassanite, glauberite, cesanite, eugsterite, hydroglauberite, syngenite, gorgeyite, polyhalite, koktaite, ye'elimite, ettringite, bentorite, celestine, kalistrontite, or baryte.

In some embodiments, the apparatus further comprises at least one of a solvent jet intensifier pump, a solvent jet crankshaft pump, or a direct-drive pump configured to increase the pressure of the rapidly moving liquid.

In some embodiments, the apparatus further includes a jewel orifice between the high-pressure solvent compartment and the mixing tube.

In some embodiments, the apparatus further includes a heater configured to raise the temperature of the jet after passing through the orifice.

In some embodiments, the apparatus further includes a guard configured to protect at least one of a user or the apparatus from debris from the jet of rapidly moving liquid.

In yet another aspect, embodiments relate to a system for solvent jet cutting. In some embodiments, the system comprises a pump configured to generate a jet of rapidly moving liquid comprising a retrograde soluble solute dissolved in solvent; and an orifice directing the jet of rapidly moving liquid to cut a target, such that the retrograde soluble solute is configured to precipitate out of the rapidly moving liquid after transitioning through the orifice.

In some embodiments, the solvent is an aqueous solution.

In some embodiments, the system further includes a cutting fluid chiller configured to maintain the solvent and the retrograde soluble solute at a temperature between 15° C. and 35° C. before transitioning the jet through the orifice.

### BRIEF DESCRIPTION OF DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 depicts an existing apparatus for solvent jet cutting;

FIG. 1A depicts a jewel orifice of the existing apparatus for solvent jet cutting;

FIG. 1B depicts a zone of mixing of the existing apparatus for solvent jet cutting;

FIG. 1C depicts the end of a nozzle of the existing apparatus for solvent jet cutting;

FIG. 2 shows an apparatus for solvent jet cutting in accordance with one embodiment;

FIG. 2A shows a pump to pressurize the apparatus for solvent jet cutting in accordance with one embodiment;

FIG. 2B shows a valve to add a solute to the apparatus for solvent jet cutting in accordance with one embodiment;

FIG. 2C shows a jetting nozzle of the apparatus for solvent jet cutting in accordance with one embodiment;

FIG. 2D shows the end of the nozzle of the apparatus for solvent jet cutting in accordance with one embodiment;

FIG. 2E shows a solution cutting through a stack of target workpieces in accordance with one embodiment;

FIG. 3 shows a graph of the solubility of a retrograde soluble solute in water at various temperatures in accordance with one embodiment;

FIG. 4 shows a graph of cutting speed compared to material thickness in accordance with one embodiment; and

FIG. 5 shows a method of solvent jet cutting in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Embodiments herein are directed to methods and systems for abrasive solvent jet cutting. Embodiments use a solute exhibiting retrograde soluble properties, known as a retrograde soluble solute. Retrograde soluble materials are nonpiezoelectric materials which dehydrate when heated. When a retrograde soluble solute dissolves, an exothermic reaction occurs. Crystals of retrograde soluble materials may increase in size, titrate out of solution, or both when the solution is heated. This differs from most solutes, which are configured to dissolve at higher temperatures.

Some salts may exhibit retrograde solubility. For example, gypsum may dissolve exothermically as shown below:

CaSO₄−2H₂O(s)←→Ca²⁺(aq)+SO₄²⁻(aq)+2H₂O+heat

Because heat is a product of this reaction, cutting with gypsum in a high pressure-temperature setting would push the reaction towards the titration, causing the solid crystals to reform and increase in size. Retrograde soluble solutes, such as gypsum, anhydrite, bassanite, glauberite, cesanite, eugsterite, hydroglauberite, syngenite, gorgeyite, polyhalite, koktaite, ye'elimite, ettringite, bentorite, celestine, kalistrontite, calcium sulfate, and baryte, may exhibit retrograde solubility such that the solubility decreases with the increasing temperature of a solution.

When used in a jet cutter, a dissolved abrasive may achieve a higher velocity during jetting than either a downstream abrasive injection or an upstream slurry of garnet sand. Additionally, a dissolved abrasive is less likely to clog a machine than a slurry or suspended material. Embodiments using a retrograde soluble solute direct a dissolved abrasive solution jet stream through the apparatus and heat the solution after pressurizing the stream, such that the abrasive titrates out of the solution when exiting the apparatus. This increases the efficacy of the abrasive and reduces damage to the apparatus in some embodiments.

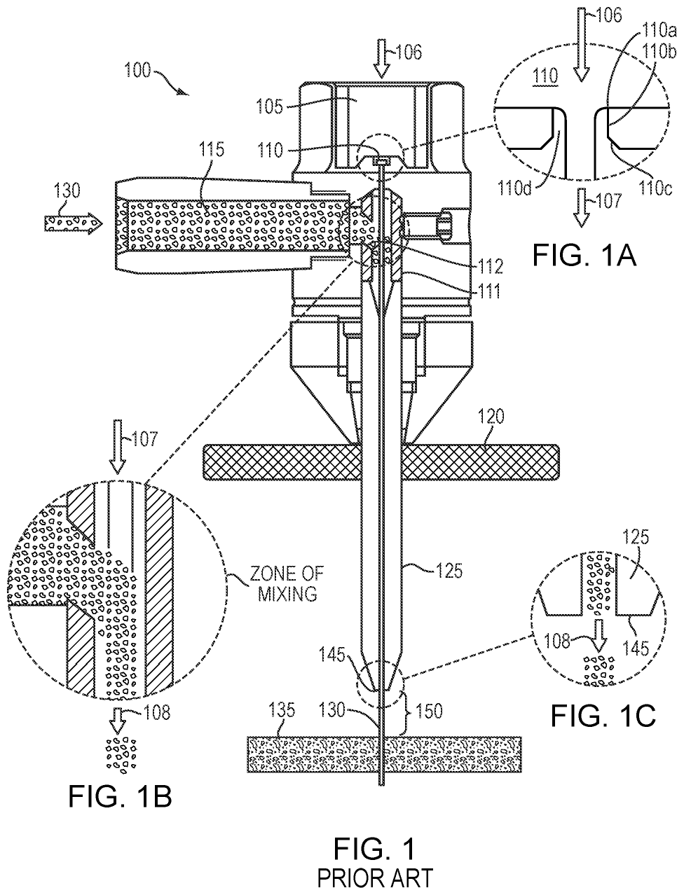

FIG. 1 shows an existing apparatus for solvent jet cutting 100. The apparatus 100 has a liquid compartment 105 configured to store a liquid 106, as well as a separate abrasive compartment 115 configured to store an abrasive material 130. The abrasive material may be garnet or a mix of materials configured to be suspended in the liquid as a slurry.

The liquid and abrasive material are stored separately and then combined in the mixing tube 111. In some embodiments, the liquid is highly pressurized and directed through an orifice 110, such as a jewel orifice, before entering the mixing tube 111. As shown in FIG. 1A, the jewel orifice 110 typically contains the orifice hole itself with a leading inlet edge 110a, an orifice wall 110b, and a tapered downstream exit 110c. The highly pressurized liquid entering the orifice typically separates from the orifice wall 110b at the inlet edge 110a. In some embodiments, there is a separation 110d of the fluid jet 107 from the orifice wall 110b.

FIG. 1B depicts a zone of mixing of the existing apparatus for solvent jet cutting. The abrasive material 130 may be added downstream from the already flowing liquid jet 107, so that the abrasive material can be accelerated and used to cut an object target workpiece 135 at an appropriate speed. After entering the mixing tube 111, the mixing tube may be configured to direct through a nozzle 125 the rapidly moving liquid jet 107 while combining the abrasive material 130 from the abrasive compartment 115 thus forming an abrasive cutting jet 108. As shown in greater detail in FIG. 1C, this abrasive cutting jet 108 may be propelled by the apparatus 100 out of the nozzle end 145 a certain distance 150 to enable cutting of an object target workpiece 135.

During propulsion, the abrasive material contained in the jet 108 may wear down the mixing tube 111 and the nozzle 125 or may clog the mixing tube 111 through repeated use. The mixing tube 111 and the nozzle 125 may include fortification against the wear and tear of abrasive material in the abrasive cutting jet 108.

In existing apparatuses 100, the abrasive material may comprise garnet having a size from 50 mesh to 220 mesh. Existing apparatuses 100 may accelerate smaller abrasive material at higher speeds to cut a target or may accelerate larger material at lower speeds to cut a target.

In existing structures, the apparatus 100 may include a guard 120. The guard 120 may be used to prevent backsplash from the abrasive emitting from the nozzle 125. The guard 120 may ensure that the abrasive does not cut the outside of the apparatus or splash into a user's face.

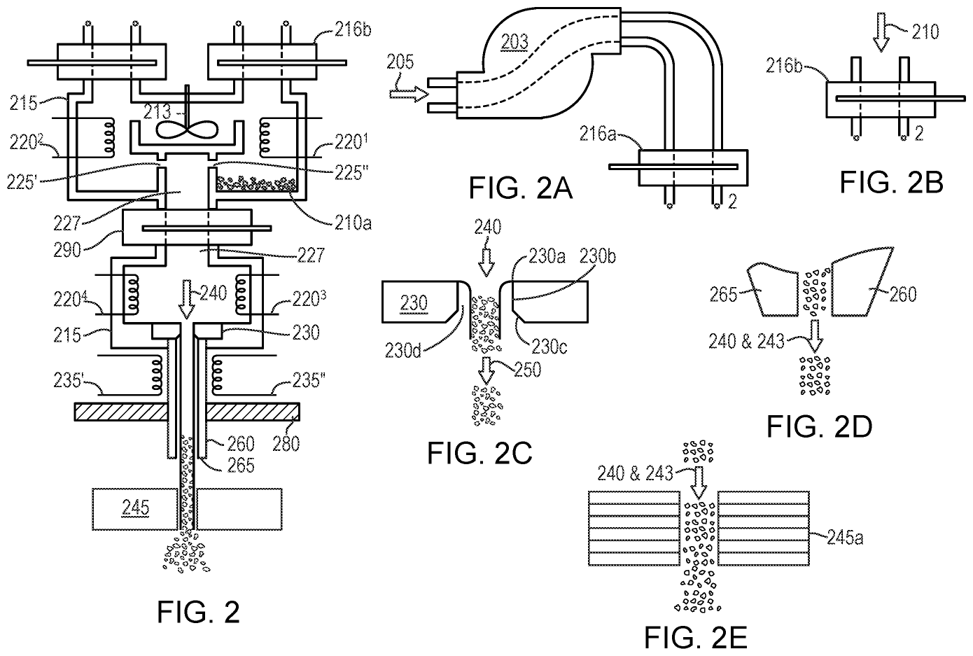

FIG. 2 shows an apparatus 200 for solvent jet cutting in accordance with one embodiment. In some embodiments, the solvent jet cutting apparatus 200 may be attached 2 to a pump 203, as shown in FIG. 2A, to pressurize the contents in the apparatus. In some embodiments, attachment 2 may comprise a permanent attachment, such as a glue, solder, or epoxy, or may comprise a detachable attachment 2.

In some embodiments, a solvent 205 may be added to a vessel 215. In some embodiments the solvent maybe sealed in vessel 215 by valve 216a. The solvent 205 may be an aqueous solution or liquid, such as water. In some embodiments, the solvent 205 may be an organic solvent, such as an alkyl alcohol, alkyl ketone, alkyl nitrile, nitroalkane, or halo-alkane.

As shown in greater detail in FIG. 2B, a solute 210, such as a retrograde soluble solute, may be added to the vessel 215, such that the solute and solvent may mix in the vessel. In some embodiments solute 210 may be sealed into vessel 215 by valve 216b. The solute 210 may be an abrasive solute. In some embodiments, the valve 216b may be attached 1 to the apparatus of FIG. 2. In some embodiments, attachment 1 may comprise a permanent attachment, such as a glue, solder, or epoxy.

In some embodiments, after the solvent 205 is loaded into the pressurized vessel 215, the pump 203 may then be used to pressurize and direct the solvent 205 from the vessel 215 through at least one orifice 225′, 225″ and a tube 227. In some embodiments, the solvent 205 may be already pressurized before entering the vessel 215.

In some embodiments, a user may be able to control the pressure of the solution. For example, embodiments may use a pump 203 capable of creating very high pressure, such as a jet intensifier pump, a crankshaft, or a direct-drive pump. A user may be able to alter the pressure within the device, depending on the type of target and the speed at which the user desires to cut the target workpiece 245 or 245a.

In some embodiments, the vessel 215 may act as a reservoir, such that the solvent 205 and retrograde soluble solute 210 may remain in the vessel 215 and be pressurized by a high-pressure pump 203. In some embodiments, the solute 210 may be readily soluble in the solvent 205. In some embodiments, the apparatus 200 may include a mixing tool 213 to assist in dissolving the solute 210 in the solvent 205. In some embodiments excess solute 210a may be added to vessel 215 to ensure supersaturation of the solution. In some embodiments, the mixing tool may be surrounded by at least one cooler 220^{N} to reduce temperature of the solution and increase supersaturation of the solution. In some embodiments, the mixing tool 213 may be surrounded by a plurality of coolers 220¹, 220².

In some embodiments, the solute 210 and solvent 205 may be combined in a pressurized vessel 215. In some embodiments, the vessel 215 may create a supersaturated solution with the solvent 205 and the solute 210, such that the concentration of the solute 210 is increased beyond the saturation point. In some embodiments, the supersaturated solution may be created by decreasing the temperature of the vessel 215 or the temperature of the solution. In some embodiments, the supersaturated solution may be created by increasing the pressure of the solution of the solute 210 and the solvent 205 in the vessel 215. In some embodiments, the solute 210 and solvent 205 combination will experience enhanced solubility at the elevated pressures applied to the vessel 215 during jetting. In some embodiments, the solute 210a may experience increased solubility in the solvent 205 when direct pressure or force is applied to the solute, for example, by squeezing the mass of the solute 210a by any means commonly recognized by one of ordinary skill in the art.

In some embodiments, the apparatus 200 may comprise a cooler 220^{N} or a plurality of coolers 220¹, 220², 220³, 220⁴, configured to increase the saturation of the solute 210 in solution. Although the solubility of many solutes in solvents increases with temperature, a retrograde soluble solute 210 has a solubility that decreases with an increasing temperature of the solution. When adding a solute 210 which exhibits retrograde solubility to a solvent 205, decreasing the temperature of the solution will increase the solubility of the retrograde soluble solute 210 in some embodiments. In some embodiments, dissolving the solute 210 in a lower temperature solvent 205 will create a supersaturated solution, designed to precipitate out solute 210 if the temperature rises above a certain value.

In some embodiments, the cooler 220^{N} may keep the temperature of the solution between 15° C. and 35° C. In some embodiments, the range of temperature may depend on one or both of solvent 205 and solute 210 and may be based on at least one of the freezing point of the solvent 205, the boiling point of the solvent 205, the solubility of the solute 210 in the solvent 205 at different temperatures, or any combination thereof. Some apparatuses 200 may maintain the temperature of the solution at a range of temperatures to reduce the likelihood of the solution freezing or the solute titrating out of solution before exiting the apparatus. For example, if the solvent 205 were to have a freezing point of 15° C. and a boiling point of 35° C., the cooler 220^{N} of the apparatus 200 would be configured to keep the solvent 205 at a temperature range well below 35° C. to prevent the solvent 205 from boiling and well above 15° C. to prevent the solvent 205 from freezing.

In some embodiments, the range of temperature may ensure that the retrograde soluble solute 210 remains in solution, but the solution does not freeze. In some embodiments, the range of temperature may be selected such that, when the solution is directed out of the vessel, the solute 210 may precipitate out of solution. In some embodiments, some solutes 210 may precipitate out of solution at different temperatures.

In some embodiments, the liquid solution may travel through the apparatus 200 through at least one tube 227. In some embodiments, the tube 227 may be a mixing tube, such that the solute 210 and solvent 205 may continue to mix after passing through the control 290 in the vessel 215.

In some embodiments, the tube 227 may have orifices 225′, 225″ configured to control the stream of solution, such that the solution may be stopped from entering the jetting nozzle or jewel orifice 230. In some embodiments, orifices 225′, 225″, such as a jewel orifice, may be configured to control the stream of the solution. Although FIG. 2 shows two orifices 225′, 225″ configured to control the solution entering the jetting nozzle 230, a person having ordinary skill in the art would recognize that an apparatus may have only one orifice or a plurality of orifices 225^{N} to control the solution entering the jetting nozzle 230 in some embodiments.

In some embodiments, the solution 240 may pass through control 290 and into a high-pressure jetting orifice, such as a jewel orifice 230. In some embodiments, and as shown in greater detail in FIG. 2C, the high-pressure jewel orifice 230 contains the orifice hole itself with a leading inlet edge 230a, an orifice wall 230b, and a tapered downstream exit 230c. The highly pressurized solution 240 entering the orifice typically separates from the orifice wall 230b at the inlet edge 230a. In some embodiments, there is a separation 230d of the high-speed solution jet 250 from the orifice wall 230b. As solution 240 passes into the orifice hole the pressure drops and the temperature increases as the apparatus accelerates the solution 240 into a high-speed solution jet 250. In some embodiments, the solute 210, exhibiting retrograde solubility, will begin to precipitate 243 out of solution jet 250 as the jet 250 exits the orifice 230.

In some embodiments, the solute 210 will substantially precipitate out of the solution jet 250 as the jet 250 exits the orifice 230. In some embodiments, 0% of the solute 210 will precipitate out of the solution jet 250 before the jet 250 exits the orifice 230. In some embodiments, 5% of the solute 210 will precipitate out of the solution jet 250 before the jet 250 exits the orifice 230. In some embodiments, 10% of the solute 210 will precipitate out of the solution jet 250 before the jet 250 exits the orifice 230. In some embodiments, 15% of the solute 210 will precipitate out of the solution jet 250 before the jet 250 exits the orifice 230. In some embodiments, 20% of the solute 210 will precipitate out of the solution jet 250 before the jet 250 exits the orifice 230.

In some embodiments, at least 30% of the solute 210 will precipitate out of the solution jet 250 after the jet 250 exits the orifice 230. In some embodiments, at least 40% of the solute 210 will precipitate out of the solution jet 250 after the jet 250 exits the orifice 230. In some embodiments, at least 50% of the solute 210 will precipitate out of the solution jet 250 after the jet 250 exits the orifice 230. In some embodiments, at least 60% of the solute 210 will precipitate out of the solution jet 250 after the jet 250 exits the orifice 230. In some embodiments, at least 70% of the solute 210 will precipitate out of the solution jet 250 after the jet 250 exits the orifice 230. In some embodiments, at least 80% of the solute 210 will precipitate out of the solution jet 250 after the jet 250 exits the orifice 230. In some embodiments, at least 90% of the solute 210 will precipitate out of the solution jet 250 after the jet 250 exits the orifice 230. In some embodiments, at least 95% of the solute 210 will precipitate out of the solution jet 250 after the jet 250 exits the orifice 230.

In some embodiments, after the solution 240 reaches a determined pressure, the solution 240 may be directed to exit the apparatus 200 as described above. Some embodiments may use a heater 235 or a plurality of heaters 235′, 235″ to increase the temperature of the solution 240 at the exit of orifice 230 The solute 210 exhibiting retrograde solubility may precipitate 243 or titrate out of the solution 240 when the temperature of the solution 240 rises above a certain value. This value may be referred to as a spontaneous precipitation value.

In some embodiments, the solution 240 may be supersaturated such that a significant portion of the solute 210 will precipitate 243 or titrate out when the temperature of the solution rises above a certain value. In some embodiments, this precipitation process may occur rapidly. In some embodiments, the amount of supersaturation is dictated by the temperature of the original solution. For a solute 210 exhibiting retrograde solubility, the colder the liquid solvent 205, the more solute 210 capable of dissolving in the solvent 205 in some embodiments.

In some embodiments, the heater 235 may be configured to raise the temperature of the solution 240 to at least 50° C. In some embodiments, the heater 235 may be configured to raise the temperature of the solution 240 to at least 70° C. In some embodiments, the heater 235 may be configured to raise the temperature of the solution 240 to at least 80° C. In some embodiments, the heater 235 may be configured to raise the temperature of the solution 240 to at least 90° C.

In some embodiments, and as shown in more detail in FIG. 2D, the solution 240 may reach the spontaneous precipitation value towards the end 265 of the nozzle tube 260, such that solute 210 may precipitate out of the solution 240 as precipitate 243. In some embodiments, the jet of solution 240 may reach the spontaneous precipitation value after exiting the apparatus 200. For example, as the solution jet 250 strikes the target workpiece 245 the solution temperature may sharply rise, rapidly reaching the spontaneous precipitation value and thereby enhancing solute precipitation. In some embodiments, the solution 240 may increase in temperature as it travels through the nozzle tube 260 because of at least one of exposure to heaters 235, increase in pressure, or speed acceleration through the nozzle tube 260. In some embodiments, at least 5% of the solute 210 will precipitate out of the solution jet 250 after the jet 250 strikes the target workpiece 245. In some embodiments, at least 10% of the solute 210 will precipitate out of the solution jet 250 after the jet 250 strikes the target workpiece 245.

In some embodiments, the target workpiece 245 or 245a may be submerged in a liquid reaction accelerant such as hot water or solvent. In some embodiments, the target workpiece 245 or 245a can be heated by some heat source or by directing a reaction accelerant such as superheated steam or hot vapor at the target workpiece.

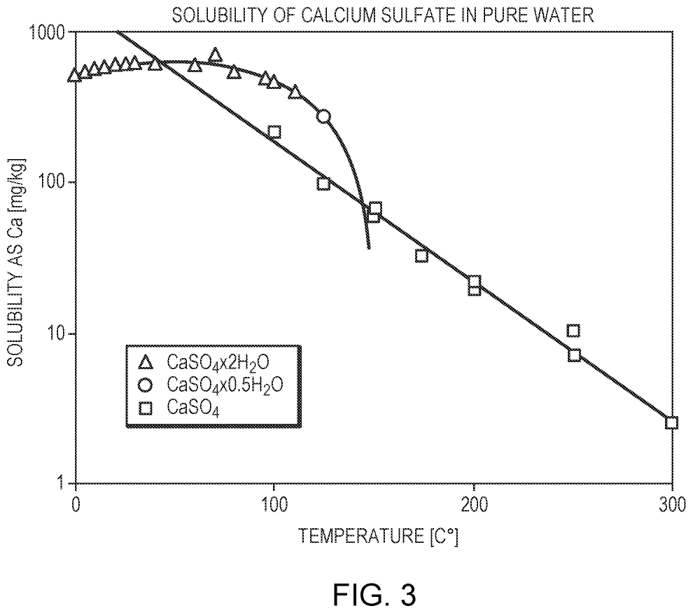

For example, as shown in FIG. 3 below, calcium sulfate may precipitate out of solution 240 at 80° C. If the abrasive solute 210 was calcium sulfate and the temperature of the solution were raised to 80° C. or higher, the solute 210 would precipitate 243 out of solution 240 in some embodiments. Therefore, in some embodiments using calcium sulfate as a solute 210, the spontaneous precipitation value would be approximately 80° C. In some embodiments, the abrasive solute 210 may include at least one of gypsum, anhydrite, bassanite, glauberite, cesanite, eugsterite, hydroglauberite, syngenite, gorgeyite, polyhalite, koktaite, ye'elimite, ettringite, bentorite, celestine, kalistrontite, or baryte. In some embodiments, the abrasive solute 210 may include a calcium sulfate, such as at least one of gypsum, anhydrite, or calcium sulfate hemihydrate. In some embodiments, the apparatus may use a plurality of abrasive solutes.

In some embodiments, the preferred abrasive solute 210 may comprise hydrated anhydrite, known as gypsum. Gypsum is a soft monoclinic mineral exhibiting perfect molecular cleavage and can be dissolved in solution at temperatures around 15° C.-35° C. In some embodiments, the abrasive solute 210 is not a piezoelectric solute. In some embodiments, the abrasive solute 210 dehydrates when heated with at least one heater 235, which causes the crystals of the solute 243 to increase in size and, in some embodiments, titrate out of solution. In some embodiments, this titration creates a slurry jet solution 240 at the heated temperature. In some embodiments, a solution 240 with a retrograde soluble solute 210, shown as precipitate 243, may exhibit spontaneous precipitation upon an adequate temperature rise of the solution 240.

In some embodiments, the apparatus 200 will not increase the temperature of the solution 240 to the spontaneous precipitation value until the solution transits a nozzle orifice 230. In some embodiments, the orifice 230 may have a diameter of approximately 0.015 inches and a nozzle tube 260 inside diameter of approximately 0.045 inches. In some embodiments, after traversing the orifice 230, the pressure of the solution 240 may drop, which may encourage spontaneous precipitation of the solute 243.

In some embodiments, once the solution 240 traverses the orifice 230, the apparatus 200 may apply heat 235 to encourage temperature rise and precipitation of solute 243. In some embodiments, the temperature of the solution 240 will increase as it traverses the mixing tube 227, such that the temperature will exceed the spontaneous precipitation value upon entering or exiting the orifice 230. Before reaching the precipitation temperature, the retrograde soluble solute may remain in solution 240 and, after reaching the precipitation temperature, the solute may precipitate out of solution 240 in some embodiments. This precipitation may create a rougher textured jet stream of solution 240. This rougher solution 240 may cut the target workpiece 245 more efficiently than standard solute and solvent combinations. By keeping the solute dissolved throughout the majority of the inside of the apparatus 200, the apparatus 200 may undergo less wear and tear from the abrasive particles over time.

In some embodiments, the solution 240 may exit the orifice 230 at a temperature greater than 80° C. In some embodiments, the temperature of the solution 240 may rise from at least one of the energy generated from the movement, internal pressure from devices within the apparatus 200, from a heater 235, or from any combination thereof. In some embodiments a shield 280 may be added to apparatus 200 to protect the apparatus and operator from splash of the cutting operation.

In some embodiments, the solution 240 may exit the apparatus 200 at a waterjet pressure of at least 50,000 psi. In some embodiments, the solution 240 may exit the apparatus 200 at a waterjet pressure of at least 55,000 psi. In some embodiments, the solution 240 may exit the apparatus 200 at a waterjet pressure of at least 60,000 psi.

In some embodiments, the solution 240 may be configured to cut various materials with a thickness of up to one inch. In some embodiments, the solution 240 may be configured to cut a metal target 245 such as steel, aluminum, stainless steel, titanium, acrylic, or Inconel. In some embodiments, the target workpiece may be a stack of target workpieces 245a, as shown in FIG. 2E.

As shown in detail in FIG. 2E, in some embodiments, the solution 240 may cut a workpiece 245 or a stack of target workpieces 245 in a straight line. In some embodiments, the solution 240 may cut a workpiece 245 in a conical shape, such that the top of the workpiece 245 has a wider cut than the bottom of the workpiece 245. In some embodiments, the solution 240 may cut a workpiece 245 in a reverse-conical shape, such that the top of the workpiece 245 has a narrower cut than the bottom of the workpiece 245. In some embodiments, the shape of the cut depends on the temperature of the workpiece 245. For example, in some embodiments, the bottom of the workpiece 245 may be hotter than the top of the workpiece 245. In such embodiments, the solution 240 may cut a wider section at the bottom of the workpiece 245 than the top because of the temperature difference. In some embodiments, the contact of the solution 240 with the workpiece 245 at the top of the workpiece 245 may generate resistance and heat the top of the workpiece 245 to a higher temperature than the bottom of the workpiece 245. In such embodiments, the solution 240 may cut a wider section at the top of the workpiece 245 than the bottom because of the temperature difference.

FIG. 3 shows a graph of the solubility of a retrograde soluble solute in water at various temperatures in accordance with one embodiment. As shown in FIG. 3, the retrograde soluble solute, calcium sulfate, may precipitate out of solution when the solution reaches approximately 80° C. In some embodiments, the solute may precipitate exponentially when the temperature is greater than 80° C., with almost all CaSO₄-2H₂O precipitating out of solution if the solution reaches 150° C. In some embodiments, the solute may precipitate out of solution in a linear fashion, as shown by the solubility of CaSO₄ in H₂O at various temperatures.

Although FIG. 3 shows a retrograde soluble solute comprising CaSO₄, the retrograde soluble solute may include at least one of gypsum, anhydrite, bassanite, glauberite, cesanite, eugsterite, hydroglauberite, syngenite, gorgeyite, polyhalite, koktaite, ye'elimite, ettringite, bentorite, celestine, kalistrontite, or baryte.

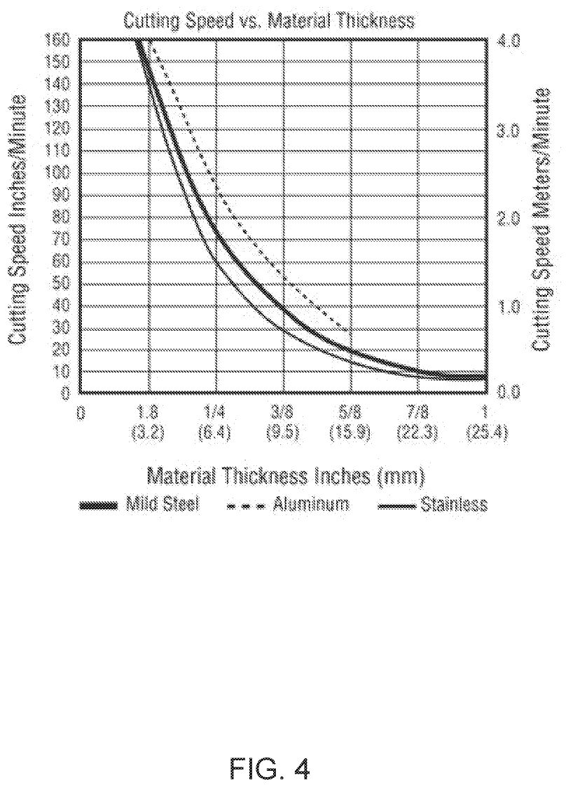

FIG. 4 shows a graph of cutting speed compared to material thickness in accordance with one embodiment. When a liquid jet cutting system is used to cut a material, the speed at which it can cut the material depends both on the type of material and the thickness of the material. At a certain velocity and pressure, a jet cutting system may cut through 0.25 mm thick aluminum at approximately 2.25 meters per minute. At the same pressure and velocity, the jet may cut through 0.25 mm thick mild steel at 1.75 meters per minute. Because steel is a harder material than aluminum, the jet may take a longer time to cut through the steel material of equal thickness. As shown in FIG. 4, the thickness of a material impacts the cutting speed of the jet in an exponential fashion.

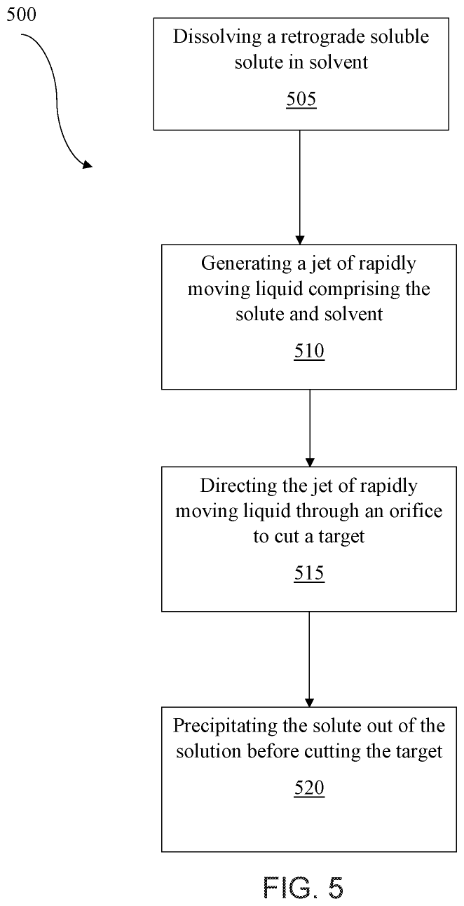

FIG. 5 shows a method of solvent jet cutting 500 in accordance with one embodiment. In some embodiments, a retrograde soluble solute is dissolved in a solvent 505. In some embodiment, the retrograde soluble solute is at least one of CaSO4, gypsum, anhydrite, bassanite, glauberite, cesanite, eugsterite, hydroglauberite, syngenite, gorgeyite, polyhalite, koktaite, ye'elimite, ettringite, bentorite, celestine, kalistrontite, baryte, or any combination thereof. In some embodiments, the retrograde soluble solute is a sulfate. In some embodiments, the solvent is an aqueous solution. In some embodiments, the solvent is water.

In some embodiments, the method 500 further includes generating a jet of rapidly moving liquid comprising the solute and solvent 510. In some embodiments, the jet of rapidly moving liquid is a super saturated solution comprising the solute and the solvent. Some embodiments may use a high-pressure pump to generate a jet of rapidly moving liquid comprising the solute and solvent 510. In some embodiments, the high-pressure pump is at least one of a solvent jet intensifier pump, a solvent jet crankshaft pump, or a direct-drive pump. In some embodiments, the solute and solvent may be combined in a reservoir connected to the high-pressure pump.

In some embodiments, the jet of rapidly moving liquid is kept at a temperature between 15° C. and 35° C. when in the apparatus.

In some embodiments, the method further includes directing the jet of rapidly moving liquid through an orifice to cut a target 515. In some embodiments, the jet of rapidly moving liquid may be heated as it approaches the orifice. In some embodiments, the jet of rapidly moving liquid may be heated after it exits the orifice to cut a target 515. In some embodiments, the solute may precipitate out of the solution of solvent and solute before cutting the target 520. In some embodiment, the solute may exhibit retrograde solubility, such that the heating of the liquid causes the solute to precipitate out of solution before cutting the target 520. In some embodiments, the solute may precipitate out of solution when the temperature of the jet is above 25° C.

In some embodiments, directing the jet of rapidly moving liquid through the orifice causes the temperature of the jet to rise and the retrograde soluble solute to precipitate out of the rapidly moving liquid before cutting the target 520. In some embodiments, the solution jet 510 may reach the spontaneous precipitation value after exiting the apparatus 200. For example, as the solution jet comprising the solute and solvent 510 strikes the target workpiece the solution temperature may sharply rise, rapidly reaching the spontaneous precipitation value and thereby enhancing solute precipitation. In some embodiments, the target workpiece may be submerged in a liquid reaction accelerant such as hot water or solvent. In some embodiments, the target workpiece can be heated by some heat source or by directing a reaction accelerant such as superheated steam or hot vapor at the target workpiece.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for abrasive solvent jet cutting comprising:
generating, with a high-pressure pump, a jet of rapidly moving liquid comprising a retrograde soluble solute dissolved in solvent; and
directing the jet of rapidly moving liquid through an orifice to cut a target, such that the retrograde soluble solute is configured to substantially precipitate out of the rapidly moving liquid after transitioning through the orifice.

2. The method of claim 1 wherein the retrograde soluble solute comprises at least one of gypsum, anhydrite, bassanite, glauberite, cesanite, eugsterite, hydroglauberite, syngenite, gorgeyite, polyhalite, koktaite, ye'elimite, ettringite, bentorite, celestine, kalistrontite, or baryte.

3. The method of claim 1, wherein the solvent is an aqueous solution.

4. The method of claim 1, wherein the retrograde soluble solute is configured to precipitate out of solution when the temperature of the jet is above 25° C.

5. The method of claim 1, wherein the high-pressure pump is at least one of a solvent jet intensifier pump, a solvent jet crankshaft pump, or a direct-drive pump.

6. The method of claim 1, further comprising maintaining the solvent and the retrograde soluble solute at a temperature of between 15° C. and 35° C. before directing the jet through the orifice.

7. The method of claim 1, wherein the retrograde soluble solute is a sulfate.

8. The method of claim 1, further comprising adding the retrograde soluble solute to the solvent in a reservoir connecting to the high-pressure pump.

9. The method of claim 1, wherein the solvent is water.

10. The method of claim 1, wherein directing the jet of rapidly moving liquid through the orifice causes the temperature of the jet to rise and the retrograde soluble solute to substantially precipitate out of the rapidly moving liquid.

11. An apparatus for abrasive solvent jet cutting comprising:
a storage vessel configured to store a retrograde soluble solute;
a high-pressure solvent compartment; and
a mixing tube configured to eject a jet of rapidly moving liquid through an orifice, the liquid comprising solvent from the compartment and the retrograde soluble solute from the vessel, such that the retrograde soluble solute is configured to substantially precipitate out of the rapidly moving liquid after ejecting from the orifice.

12. The apparatus of claim 11 further comprising a cutting fluid chiller configured to maintain the solvent in the high-pressure solvent compartment at a temperature between 15° C. and 35° C.

13. The apparatus of claim 11 wherein the retrograde soluble solute comprises at least one of gypsum, anhydrite, bassanite, glauberite, cesanite, eugsterite, hydroglauberite, syngenite, gorgeyite, polyhalite, koktaite, ye'elimite, ettringite, bentorite, celestine, kalistrontite, or baryte.

14. The apparatus of claim 11, wherein the apparatus further comprises at least one of a solvent jet intensifier pump, a solvent jet crankshaft pump, or a direct-drive pump configured to increase the pressure of the rapidly moving liquid.

15. The apparatus of claim 11, further comprising a jewel orifice between the high-pressure solvent compartment and the mixing tube.

16. The apparatus of claim 11, further comprising a heater configured to raise the temperature of the jet after passing through the orifice.

17. The apparatus of claim 11, further comprising a guard configured to protect at least one of a user or the apparatus from debris from the jet of rapidly moving liquid.

18. A system for solvent jet cutting comprising:
a pump configured to generate a jet of rapidly moving liquid comprising a retrograde soluble solute dissolved in solvent; and
an orifice directing the jet of rapidly moving liquid to cut a target, such that the retrograde soluble solute is configured to substantially precipitate out of the rapidly moving liquid after transitioning through the orifice.

19. The system of claim 18, wherein the solvent is an aqueous solution.

20. The system of claim 18, further comprising a cutting fluid chiller configured to maintain the solvent and the retrograde soluble solute at a temperature between 15° C. and 35° C. before transitioning the jet through the orifice.
